(19) United States
(12) Patent Application Publication
(10) Pub. No.: US 2026/0342668 A1
(43) Pub. Date: Oct. 29, 2026

(54) DEVICE, METHOD, AND SYSTEM FOR NETWORK ANALYTICS ACCURACY MONITORING

(71) Applicant: HUAWEI TECHNOLOGIES CO., LTD., Shenzhen (CN)

(72) Inventors: Clarissa MARQUEZAN, Munich (DE); Zhang FU, Kista (SE)

(73) Assignee: HUAWEI TECHNOLOGIES CO., LTD., Shenzhen (CN)

(21) Appl. No.: 19/705,962

(22) Filed: Jun. 12, 2026

Related U.S. Application Data
(63) Continuation of application No. PCT/EP2023/085874, filed on Dec. 14, 2023.

(51) Int. Cl. H04L 41/14

(52) U.S. Cl. CPC H04L 41/145

(57) ABSTRACT

A first network function (NF) is adapted to manage machine learning (ML) model and provide suitable ML model(s) to a second NF. According to the embodiments, the first NF is configured to obtain model accuracy binding information from the second NF. The model accuracy binding information indicates an association between analytics information and ML model information. The analytics information indicates an association between an analytics ID, and analytics filter information and/or analytics target. The first NF obtains model accuracy information associated with model accuracy meta information from the second NF. The model accuracy meta information indicates an association of the ML model accuracy information and the analytics information. The first network function is configured to determine whether to update the ML model information based on the model accuracy binding information and/or the model accuracy meta information.

### CROSS-REFERENCE TO RELATED APPLICATIONS

This application is a continuation of International Application No. PCT/EP2023/085874, filed on Dec. 14, 2023, the disclosure of which is hereby incorporated by reference in its entirety.

### TECHNICAL FIELD

The embodiments relate to the field of communication. For instance, the embodiment relate to devices, methods and a system for network analytics accuracy monitoring.

### BACKGROUND

In the context of 5G, 6G and beyond communications networks, the Network Data Analytics Function (NWDAF) plays a crucial role in collecting, processing, analysing, and providing insights from various network data sources. The NWDAF may be adapted to perform or may contain various logical functions for different purposes, such as Analytics Logical Function (AnLF) and Model Training Logical Function (MTLF).

An NWDAF comprising AnLF (may also be referred to as NWDAF-AnLF, or simply AnLF) is responsible for collecting the analytical request and sending the response to the consumer. For this purpose, the AnLF may be configured to collect meaningful information from network data and make a decision (e.g., perform prediction/estimation) using advanced analytics techniques, e.g., machine learning (ML) models (or algorithms). An NWDAF comprising MTLF (may also be referred to as NWDAF-MTLF, or simply MTLF), on the other hand, is responsible for training, managing, and updating the ML models used by the AnLF.

### SUMMARY

The 3rd Generation Partnership Project (3GPP) specification TS 23.288 v18.3.0 defines that the AnLF can monitor both the analytics accuracy and the ML model accuracy information. The accuracy information is provided to the MTLF if the MTLF is subscribed to receive such information, which can then trigger any of the following actions:
Re-training of ML models: if the accuracy information indicates that a model has degraded, the MTLF can trigger the re-training of the model. This process involves updating the model's parameters based on new data and improving its performance.
Re-selection of ML models: the MTLF can also re-select the ML model that is associated with a particular analytics ID. This may be necessary if the current model is no longer performing as well as it could, or if a new model has been developed that is more accurate or efficient.

The ability to monitor and manage accuracy information is essential for ensuring the reliability and effectiveness of network analytics. By actively updating and improving ML models, the AnLF can provide more accurate and timely insights, which can be used to optimize network performance, enhance user experience, and identify and resolve potential issues.

Current 3GPP specification allows for the AnLF to have multiple subscriptions to the same analytics ID (e.g., AMF subscribes to the same analytics ID with different analytics targets, i.e., UEs or group of UEs, and/or different analytics filter information) that are using the same unique ML model identifier. This means that one trained ML Model may be associated with a unique ML model identifier and a set of ML Model Filter Information and ML Model target (e.g., a general trained model for an analytics ID), may fit different specific subscriptions for the generation of the analytics ID (e.g., a specific scenario that could be detectable/predictable by a generic trained ML Model).

As a consequence, the AnLF may be faced with the situation in which for a given specific usage of the trained ML model (e.g., a subscription for analytics ID “A” with filters “B”) the analytics accuracy is high, and for another specific usage of the same trained ML model (e.g., subscription for analytics ID “A” with filters “C”) the analytics accuracy is low. When AnLF generates the ML Model accuracy (per analytics ID and ML model identifier), these differences on the accuracy for specific usage of the model are diluted if not completely lost.

Overall, the current ML model provisioning, update and retraining scheme may have the following problems.

Firstly, the specific usage of ML models for different application scenarios is not considered. This can lead to inaccurate (or incomplete) ML model accuracy information being sent to the MTLF, which can in turn trigger unnecessary actions such as retraining or re-selection of ML models.

Secondly, it does not allow for the MTLF to differentiate between ML models that are suitable for different application scenarios. This can lead to the MTLF retraining or re-selecting ML models that are not suitable for specific usage scenario, resulting in wasted resources and sub-optimal decisions.

In view of the above-mentioned problems and disadvantages, this embodiment aims to improve network accuracy monitoring and reporting in communication networks. For instance, an objective of this embodiment may be to improve ML accuracy information reporting scheme between the AnLF and the MTLF. A further objective of this embodiment may be to prevent the MTLF from performing unnecessary signaling and/or determining imprecise ML model degradation information, and to prevent the MTLF from triggering of: imprecise or unnecessary reselection of ML models, or imprecise decision to not retrain or reselect an ML model, in response to ML model request from NWDAF with AnLF.

A first aspect of the embodiments provides a first network function (NF) entity (e.g., MTLF) for ML model training (or provisioning) in a mobile communication network. The first NF entity is configured to obtain model accuracy binding information from a second network function entity (e.g., an AnLF). The model accuracy binding information is indicative of at least one association between an analytics information and ML model information. The analytics information is indicative of at least one association between an analytics identifier (ID), and one or more of analytics filter information and analytics target. The first NF entity is further configured to obtain model accuracy information associated with model accuracy meta information from the second NF entity. The model accuracy meta information is indicative of ML model accuracy information, and associated analytics information. The ML model accuracy information is of an association of the ML model accuracy information and the analytics information. The first NF entity is further configured to determine whether to update the ML model information (and/or the ML model identified by the ML model information) based on the model accuracy binding information and/or the model accuracy meta information.

Optionally, the ML model accuracy information may be indicative of performance and/or quality information about the ML model.

Optionally, the model accuracy meta information may be comprised (or embedded) in the model accuracy information, or may be annexed to the model accuracy information, or may be linked to the model accuracy information, or the like.

The model accuracy binding information may be used to indicate not only which analytics (identified by an analytics ID) corresponds to which ML model, but also a specific usage scenario (identified by analytics filter information and/or analytics target information) of the analytics that is associated with the ML model. Based on the received model accuracy meta information and the binding information, the first NF entity can determine, in a specific usage scenario, whether an ML model is imprecise or underperforming. Therefore, the risk of the first NF entity of determining imprecise quality/correctness about the ML Model for an analytics ID used in different situations may be reduced.

It is noted that the first NF entity is further configured to determine whether to update the ML model based further on the model accuracy information.

In an embodiment of the first aspect, the model accuracy meta information may further indicate an association of analytics accuracy information and one or more of: an analytics ID, the analytics filter information, the analytics target, and the ML model information.

Optionally, the analytics accuracy information may be indicative of performance and/or quality information about an analytics identified by the analytics ID.

The use of analytics accuracy information and/or model accuracy information for the determining the retraining and/or re-selection of ML Models is aligned with the definitions of TS 23.288 V18.3.0 for instance as described in Clause 6.2E.2 and/or Clause 6.2E.3.3. Therefore, for simplicity they are not described in detail in this embodiment.

In a further embodiment of the first aspect, the first network function entity may be configured to obtain the model accuracy binding information from a request from the first network function entity. The request is indicative that the second network function entity is able to provide the ML model accuracy information with respect to the ML model information comprised in the model accuracy binding information.

In this way, the first network function may be aware that the second network function supports the accuracy reporting with specific usage scenario.

In a further embodiment of the first aspect, the first network function entity may be configured to send indication information to the second network function entity for requesting the model accuracy meta information.

In this way, the first network function may explicitly request the second network function to provide the accuracy information with specific usage scenario(s).

In a further embodiment of the first aspect, the indication information for requesting the model accuracy meta information may be comprised in a subscription request sent by the first network function entity to the second network function entity.

In a further embodiment of the first aspect, the indication for requesting the model accuracy meta information may comprise one or more of:
a flag indicating whether the model accuracy meta information is required
an ML model ID associated with an analytics ID;
an ML model ID associated with one or more of an analytics ID, analytics filter information, and analytics target;
an ML model ID associated with one or more ML model accuracy IDs, wherein each ML model accuracy identifier identifies at least one ML model ID association with at least one analytics ID, and analytics filter information and/or analytics target; and
one or more ML model accuracy IDs, wherein each ML model accuracy ID identifies a tuple of an ML model ID and corresponding analytics information.

In a further embodiment of the first aspect, the first NF entity may be further configured to update the ML model information based on the ML model accuracy meta information. The updated ML Model information is associated with a new ML Model ID or with a previous ML Model ID.

In a further embodiment of the first aspect, for updating the ML model information, the first NF entity may be configured to perform any of the following: determine new ML model information as the updated ML model information; or retrain the ML model to obtain a retrained ML model in order to update the ML model information.

In a further embodiment of the first aspect, the first NF entity may be further configured to provide the updated ML model information and/or an ML model specialization indication to the second network function entity. The ML model specialization indication is indicative of an association of the ML model information and/or the updated ML model information, and corresponding analytics information.

For example, the first NF entity may be configured to provide the updated ML model information. Alternatively, the first NF entity may be configured to provide an ML model specialization indication. Alternatively, the first NF entity may be configured to provide the updated ML model information and the ML model specialization indication.

A second aspect of this embodiments provides a second NF entity (e.g., AnLF) for supporting ML model training in a mobile communication network. The second NF entity is configured to provide model accuracy binding information to a first NF entity (e.g., MTLF) for ML model training. The model accuracy binding information is indicative of at least one association between an analytics information and ML model information. The analytics information is indicative of at least one association between an analytics ID, and one or more of analytics filter information and analytics target. The second NF entity is further configured to obtain model accuracy information of the ML model information (or, of an ML model identified by the ML model information), and generate model accuracy meta information indicating an association of the model accuracy information and the analytics information. The second NF entity is configured to provide the model accuracy information associated with the model accuracy meta information to the first NF entity.

Optionally, for obtaining the model accuracy information, the second NF entity may be configured to generate an analytics output using an ML model identified by the ML model information, and verify the analytics output (e.g., at a later time point), to obtain the model accuracy information.

In an embodiment of the second aspect, the model accuracy meta information may further comprise analytics accuracy information associated with one or more of an analytics ID, the analytics filter information, the analytics target, and the ML model information.

In a further embodiment of the second aspect, the second NF entity may be configured to provide the model accuracy binding information to the first network function entity through a request. The request is indicative that the second network function entity is able to provide the ML model accuracy information with respect to the ML model information comprised in the model accuracy binding information.

In a further embodiment of the second aspect, for providing the model accuracy meta information, the second network function entity may be configured to receive indication information from the first network function entity for requesting the model accuracy meta information.

In a further embodiment of the second aspect, the second NF entity may be further configured to:
receive updated ML model information and/or a machine learning model specialization indication from the first network function entity, in which the machine learning model specialization indication is indicative of an association of the ML model information and/or the updated ML model information, and corresponding analytics information; and
update the ML model information based on the updated ML model information and the machine learning model specialization indication.

The second NF entity of the second aspect may share the corresponding optional features and the same effect as the first NF entity of the first aspect.

A third aspect of embodiments provides a system comprising at least one first NF entity according to the first aspect or any embodiment thereof, and at least one second NF entity according to the second aspect or any embodiment thereof.

A fourth aspect of embodiments provides a method applied to a first NF entity for ML model training in a mobile communication network. The method comprises the following steps or operations:
obtaining model accuracy binding information from a second NF entity, in which the model accuracy binding information is indicative of at least one association between an analytics information and ML model information, wherein the analytics information is indicative of at least one association between an analytics ID and one or more of analytics filter information and analytics target; and
obtaining model accuracy information associated with model accuracy meta information from the second NF entity, wherein the model accuracy meta information is indicative of an association of the ML model accuracy information and the analytics information; and
determining whether to update the ML model based on the model accuracy binding information and/or the model accuracy meta information.

The method of the fourth aspect may share the same optional features and the same effect as the first NF entity of the first aspect or any embodiment thereof.

A fifth aspect of embodiments provides a method applied to a second NF entity for supporting ML model training in a mobile communication network. The method comprises the following steps or operations:
providing model accuracy binding information to a first NF entity, in which the model accuracy binding information is indicative of at least one association between an analytics information and ML model information, in which the analytics information is indicative of at least one association between an analytics ID, and one or more of analytics filter information and analytics target;
obtaining model accuracy information of the ML model information;
generating model accuracy meta information indicating an association of the model accuracy information and the analytics information; and
providing the model accuracy information associated with the model accuracy meta information to the first NF entity.

The method of the fifth aspect may share the same optional features and the same effect as the second NF entity of the second aspect.

A sixth aspect of embodiments provides a computer program comprising instructions which, when the program is executed by a computer, cause the computer to carry out the method according to the fourth aspect or the fifth aspect.

A seventh aspect of embodiments provides a non-transitory computer-readable medium comprising instructions which, when executed by a computer, cause the computer to carry out the method according to the fourth aspect or the fifth aspect.

An eighth aspect of embodiments provides a chipset comprising instructions which, when executed by the chipset, cause the chipset to carry out the method according to the fourth aspect or the fifth aspect.

It has to be noted that all devices, terminals, elements, units, and means described in the embodiments could be implemented in software or hardware elements or any kind of combination thereof. All steps or operations which are performed by the various entities described in the embodiments as well as the functionalities described to be performed by the various entities are intended to mean that the respective entity is adapted to or configured to perform the respective steps or operations and functionalities. Even if, in the following description, a specific functionality or step or operation to be performed by external entities is not reflected in the description of a specific detailed element of that entity, which performs that specific step or operation or functionality, it may be clear for a skilled person that these methods and functionalities can be implemented in respective software or hardware elements, or any kind of combination thereof.

### BRIEF DESCRIPTION OF DRAWINGS

The above-described aspects and embodiments may be explained in the following description in relation to the enclosed drawings, in which

FIG. 1 shows a first NF entity 110 and a second NF entity 120 according to the embodiments;

FIG. 2 shows an example of a method according to the embodiments;

FIG. 3 shows a further example of a method according to the embodiments;

FIG. 4 shows a diagram of a method applied to a first network function entity; and

FIG. 5 shows a diagram of a method applied to a second network function entity.

### DETAILED DESCRIPTION OF EMBODIMENTS

Without loss of generality, exemplary explanations of terms used in the embodiments are given below.

Accuracy Monitoring: a general term used to describe the process of identifying the performance (and/or an associated measurement) of an analytics (e.g., machine learning process such as inference or training).

Analytics Accuracy Monitoring: an activity relates to the accuracy monitoring of an Analytics ID during ML inference processes performed by an NWDAF with AnLF logical functionality.

ML Model Accuracy Monitoring assisted by AnLF: related to the accuracy monitoring of an ML model (e.g., identified by a unique ML Model identifier) and an Analytics ID performed by an NWDAF with AnLF logical functionality and provided to the NWDAF with MTLF logical functionality.

Feedback Type: defines the type of ML Model accuracy information to be generated (and/or provided) to an entity requesting such information. Another possible understanding for the feedback type is that it defines the tuple that is associated with the ML Model accuracy information generated (e.g., monitored and/or provisioned) or to be generated (e.g., monitored and/or provisioned) by the NWDAF with AnLF.

General Feedback Type: information that indicates to NWDAF with AnLF that the ML model accuracy information may be monitored and/or generated and/or calculated and/or provisioned and/or calculated based on the tuple of [analytics ID, and unique ML Model identifier].

Specific Feedback Type: information that indicates to NWDAF with AnLF that the ML model accuracy information may be monitored and/or generated and/or calculated and/or provisioned and/or calculated based on the ML model accuracy meta information, e.g., the tuple [unique ML Model identifier, analytics ID, analytics Filter Information and/or Analytics Target].

Indication for ML Model accuracy meta information request (or indication for requesting ML Model accuracy meta information or indication for ML Model accuracy meta information or indication information for requesting model accuracy meta information): defines a request and/or subscription to obtain the ML Model accuracy meta information.

ML model accuracy meta information (also referred to as model accuracy meta information): defines the association of a unique ML Model identifier and/or ML Model Information with an ML Model accuracy information for an analytics ID, and Analytics Filter Information and/or Analytics target. This association may be understood as a mapping.

Indication of ML Model specialization (or machine learning, ML, model specialization indication): in broader terms defines the information (and/or one or more parameters) used to map a unique ML Model ID and/or ML Model Information to an analytics ID, and Analytics Filter Information and/or Analytics target. It may also be understood as defining a relationship between a previous unique ML model identifier and/or ML Model Information associated with an analytics IDs to a new unique ML model identifier and/or new ML Model Information associated with the same analytics ID and further indicating the specific Analytics Filter Information and/or Analytics target related to the analytics ID.

Accuracy binding information (or model accuracy binding information): defines the information that associates and/or defines the mapping and/or defines the relationship among unique ML Model identifier (optionally an ML Model Filter Information and/or ML Model target) with analytics ID, analytics filter information and/or analytics target
ML model accuracy information (or model accuracy information): defines a performance and/or quality information about an ML Model.

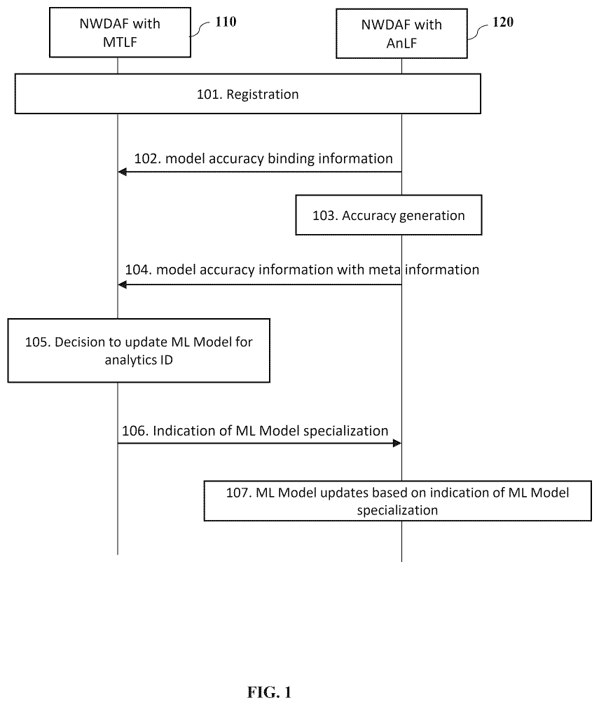

In FIGS. 1-5 below, corresponding elements may share the same features and function likewise.

FIG. 1 shows a first NF entity 110 and a second NF entity 120 of the embodiments. The first NF entity 110 is for ML model training in a mobile communication network. For instance, the first NF entity 110 may be an MTLF. In the embodiments, MTLF is used to refer to the first NF entity 110. The second NF entity 120 is for supporting ML model training in a mobile communication network. The second NF entity 120 is adapted to provide analytic results based on trained model received from the first entity 110. For instance, the second NF entity 120 may be an AnLF. In the embodiments, AnLF is used to refer to the second NF entity 120.

In the embodiments, the NWDAF architecture and Nnwdaf service interface defined in 3GPP TS 23.288 v18.3.0 may be considered as a baseline. Terms used in the embodiments may have the same definition as in the TS 23.288 (unless specified otherwise), which includes but not limited to: analytics ID, Analytics Filter Information (or Analytics Filter), Analytics Target (or Analytics Target of reporting or Target of Analytics Reporting), ML Model, ML Model Filter Information, ML Model Information, unique ML Model identifier, ML Model Target (or Target of ML Model, or ML Model Target of reporting).

As depicted in FIG. 1, MTLF 110 and AnLF 120 are illustrated. For supporting ML training at MTLF 110, AnLF 120 is adapted to provide ML Model accuracy information to MTLF 110. Based on the ML model accuracy information, MTLF 110 may take follow-up steps or operations when it detects that an ML Model is suffering some performance degradation. Optionally, AnLF 120 may be further adapted to provide analytics accuracy information to MTLF 110. Based on the model accuracy information, and/or model accuracy binding information, and/or the model accuracy meta information, and/or analytics accuracy information, the MTLF 110 may be adapted to determine whether to update the ML model if the ML model is not fit for the analytics, or underperformances for the analytics. The interactions may comprise the following steps or operations.

It is noted that according to the definitions of analytics and ML accuracy monitoring defined in 3GPP TS 23.288 V18.3.0, different entities may be adapted to control the accuracy of the ML Model associated with an analytics ID. For instance, the NWDAF containing AnLF 120 may be adapted to track (or check) with its own parametrization the analytics accuracy information for a given ML Model #A associated with an analytics ID #A. It is also possible that the NWDAF containing the MTLF 110 may be adapted to track (or check) with its own parametrization the ML Model accuracy information for the same given ML Model #A associated with the analytics ID #A. Since these can be completely independent processes, it is possible that the two entities AnLF and MTLF 110 may have the same view of the accuracy for the association ML Model #A and Analytics ID #A. It is also possible that the two entities AnLF and MTLF 110 may have, at a given point in time, different views of the accuracy for the association ML Model #A and Analytics ID #A. For instance, the ML Model accuracy for ML Model #A with analytics ID #A at time T in the perspective of MTLF 110 may not be the same analytics accuracy for analytics ID #A with ML Model #A at time T from the perspective of AnLF. At time T, MTLF 110 may have an ML accuracy value still reflecting the accuracy for the ML Model #a trained at a different time T-x. When MTLF 110 obtains the analytics accuracy information from AnLF, the MTLF 110 can identify whether the “stored” accuracy for ML model associated with analytics ID A may be rechecked.

Step or operation 101: AnLF 120 uses a service called “Nnwdaf_MLModelMonitor_Register” from MTLF 110 in order to indicate to MTLF 110 that it is capable to generate ML Model accuracy information enhanced with accuracy meta information (e.g., with respect to a given Analytics ID and ML model ID). This step or operation is optional and not essential for the embodiments.

MTLF 110 may be configured to obtain the model accuracy binding information from a request from AnLF 120. The request is indicative that AnLF 120 is able to provide the ML model accuracy information enhanced with meta information.

Step or operation 102: MTLF 110 receives from AnLF 120 the model accuracy binding information indicative of at least one association between analytics information and ML model information. The analytics information is indicative of at least one association between an analytics ID, and one or more of analytics filter information and analytics target. In another word, the accuracy binding information may be indicative of at least one mapping of an analytics ID, and analytics filter information and/or analytics target (e.g., [analytics ID->analytics filter and/or analytics target]). The analytics information is further associated with the ML model information comprising an ML model ID identifying an ML model. Optionally, the ML model information may further comprise ML Model filter information and/or ML model target information associated with the ML model. For instance, the accuracy binding formation may comprise information of the following format: [analytics ID->analytics filter and/or analytics target]-> [ML model ID, (optional) ML model filter information, (optional) ML model target information]).

It is noted that the analytics/ML model filter information may be used to indicate a service type that the analytics/ML model is applied to, and the target may be used to indicate to which UE(s)/terminal(s) the analytics/ML model is applied.

Optionally, step or operation 102 may be performed together with step or operation 101. Alternatively, step or operation 102 may be performed separately, for instance, using a different service invoked between AnLF 120 and MTLF 110.

Step or operation 103: AnLF 120 performs its tasks of analytics collection (or generation), for each subscription and for an Analytics ID, using an ML model (identified by a corresponding ML model ID) indicated by MTLF 110.

AnLF 120 is configured to use an ML model for providing analytics information to an analytics consumer. During providing the analytics information, AnLF 120 may be configured to collect/determine analytics accuracy associated with the ML model supporting the generation of the analytics information. For instance, AnLF 120 may use an ML model for the generation of an analytics for traffic prediction. Later on, when AnLF 120 obtains a real traffic statistic, AnLF 120 may use the real traffic statics (as a ground-truth) to evaluate the performance of the ML model used for the generation of the analytics information, in order to obtain the analytics accuracy information of the ML model. For example, from the perspective of AnLF 120 in a given time, AnLF 120 determines that the ML model for the analytics for traffic predictions. For instance, the analytics model accuracy information may comprise confidence level (0-100%) of a prediction result for the ML model used at that moment y AnLF.

Step or operation 104: MTLF 110 is configured to obtain model accuracy information associated with model accuracy meta information from AnLF 120. The model accuracy meta information is indicative of an association of the ML model accuracy information and the analytics information.

Optionally, MTLF 110 may be configured to send indication information to AnLF 120 for requesting the model accuracy meta information. Optionally, MTLF 110 may be configured to subscribe to ML model accuracy monitoring information from a registered AnLF 120 for a given analytics ID and unique ML model ID (e.g., through a subscription request). MTLF 110 may be configured to indicate to AnLF 120 whether the ML model accuracy monitoring may be generated with further refinements considering the mapping of a unique ML model ID to the association of analytics ID, and analytics filter information and/or analytics target information. When AnLF 120 accepts such subscription, AnLF 120 may be configured to monitor the ML model accuracy information as per indication received from MTLF 110, and provide to MTLF 110 with the ML model accuracy information comprising the ML Model accuracy meta information.

Optionally, the indication information for requesting the model accuracy meta information may comprise one or more of:
a flag indicating whether the model accuracy meta information is required;
an ML model ID associated with an analytics ID;
an ML model ID associated with one or more of an analytics ID, analytics filter information, and analytics target;
an ML model ID associated with one or more ML model accuracy IDs, in which each ML model accuracy identifier identifies at least one ML model ID association with at least one analytics ID, and analytics filter information and/or analytics target; and
one or more ML model accuracy IDs, in which each ML model accuracy ID identifies a tuple of an ML model ID and corresponding analytics information.

NOTE: it is considered that analytics ID and/or ML model ID are included as mandatory information in the indication information for requesting the model accuracy meta information (if sent).

Optionally, the ML model accuracy meta information may comprise a tuple (or an association) of:
analytics ID, and
analytics filter and/or analytics target.

Optionally, the ML model accuracy meta information may further comprise reached analytics accuracy information per distinct analytics filter and/or analytics target and/or analytics subscription associated with the unique ML model ID.

Step or operation 105: based on the model accuracy binding information and/or the model accuracy meta information, MTLF 110 is configured to determine whether to update the ML model information.

Either one of the model accuracy binding information and the model accuracy meta information may have sufficient information for MTLF 110 to determine specific analytics usage scenario. Thus, based on either one or both of the model accuracy binding information and the model accuracy meta information, MTLF 110 is able to determine whether to update the ML model information (and/or the ML model identified by the ML model information).

According to the embodiments, based on the received ML model accuracy information enhanced with ML model accuracy meta information from AnLF, MTLF 110 may be configured to determine whether to update the ML model based on the model accuracy binding information and/or the ML model accuracy meta information. For instance, MTLF 110 may be configured to trigger ML model re-training for a given unique ML model identifier associated with model accuracy meta information, or select a new unique ML Model identifier (and associated ML Model information) to be re-associated with an analytics ID.

Optionally, MTLF 110 may be configured to update the ML model information based on the model accuracy meta information. The updated ML Model information may be associated with a new ML Model ID or with a previous ML Model ID.

Optionally, for updating the ML model information, MTLF 110 may be configured to perform any of the following:
determine new ML model information as the updated ML model information; or
retrain the ML model to obtain a retrained ML model in order to update the ML model information.

Step or operation 106: MTLF 110 may be configured to generate an ML model specialization indication, which comprises an indication of updates (or changes) in: the ML model information; and/or ML model filter information; and/or ML model target; and/or ML Model ID associated to the tuple of Analytics IDs, and Analytics Filter(s) and/or Target(s), and/or to the ML Model accuracy meta information.

Step or operation 107: MTLF 110 may be configured to provide to AnLF 120 the ML Model specialization indication for an analytics ID when it sends a notification for providing new ML Model related information. Based on the received information, AnLF 120 updates the unique ML model identifier and/or the ML model information used for the generation of the analytics IDs matching the tuple of Analytics IDs, and Analytics Filter(s) and/or Target(s), which is comprised in the ML Model specialization indication for an analytics ID.

In general, MTLF 110 may be configured to provide the updated ML model information and/or a machine learning model specialization indication to AnLF 120. The machine learning model specialization indication is indicative of an association of the ML model information and/or the updated ML model information, and corresponding analytics information

In general, an NWDAF with MTLF capable of differentiating ML model accuracy per analytics ID, ML model identifier, and ML Model Filter and/or Analytics Filter Information is proposed. Accordingly, the NWDAF with MTLF may trigger an ML-retraining to refine a generic ML Model (e.g., with broad ML Model Filter Information) into a more specific trained ML model (e.g., with specialized ML Filter Information). For binding a unique ML Model ID to multiple use in analytics inference, MTLF is configured to obtain the accuracy binding information, which is the mapping of an analytics ID, and analytics filter information and/or analytics target. The mapping is associated with a given unique ML Model identifier, optionally with ML Model Filter Information and/or ML Model target.

In this way, the risk of MTLF to determine imprecise quality about the ML Model for an analytics ID used in different situations may be reduced. Further, the changes of wasting network resources or computation capabilities in re-training of ML models may be reduced. Thus, the MTLF capability to effectively identify which an inferior ML model can be improved.

In general, the model accuracy binding information of the embodiments may comprise the following information: 1. analytics information, 2. ML model information associated with the analytics information.

The analytics information is used to identify an analytics service and its specific usage scenario. The analytics information is indicative of (or comprises) the following information: 1. an analytics ID, 2. analytics target and/or analytics filter information associated with the analytics ID.

For instance, the analytics information may comprise: 1. an analytics ID, 2. analytics filter information associated the analytics ID. Alternatively, the analytics information may comprise: 1. an analytics ID, 2. analytics target information associated with the analytics ID. Alternatively, the analytics information may comprise: 1. an analytics ID, 2. analytics target and analytics filter information associated with the analytics ID.

The ML model information is used to identify an ML model. Optionally, the ML model information may indicate specific usage scenario of the ML model. The ML model information comprises an ML model ID, and optionally may comprise ML model filter and/or ML target of an ML model identified by the ML model ID.

It is noted that the model accuracy binding information may comprise association information between multiple pieces of analytics information and multiple pieces of ML model information. An example of the model accuracy binding information may be illustrated in the Table 1 below.

TABLE 1

| | Analytics Information | | | ML model information | | |
|---|---|---|---|---|---|---|
| | ID | Filter | Target | ID | Filter | Target |
| 1. | A1 | A1-F1 | A1-T1 | M1 | M1-F2 | M1-T2 |
| 2. | A1 | A1-F3 | | M2 | | |
| 3. | A1 | | A1-T3 | M1 | M1-F4 | |
| 4. | A2 | A2-F5, F6 | | M3 | | M3-T4 |

Table 1 exemplarily shows four associations. A1 and A2 refer to two different analytics services. F1, F3 and F5 refer to different analytics filter information. A1-F1 refers to analytics filter F1 is applied to (or is associated with) analytics service A1. The similar notion applies to analytics analytics target information T1 and T3. M1, M2, M3 and M4 refer to three different models. F2 and F4 refer to ML model filter information. M1-F2 refers to filter information F2 is applied to (or is associated with) ML model M1. The similar notion applies to ML model target information T2 and T4.

It is noted that the information in Table 1 is only for illustrations purpose only and does not mean the content comprises in the model accuracy binding information. The model accuracy binding information may comprise one or more of such association illustrated in Table 1. Optionally, one analytics ID may be associated with more than one analytics filter information, and/or with more than one analytics target information. For instances, as shown above in Table 1, analytics filters F5 and F6 are associated with analytics ID A2.

Optionally, the ML Model accuracy meta information may comprise (or indicate information on) one or more of the following information:
an association of [unique ML Model ID, Analytics ID, and Analytics Filter and/or Analytics Target];
an association of [unique ML Model ID, ML Model accuracy information, Analytics ID, and Analytics Filter and/or Analytics Target];
an association of [ML Model accuracy information, Analytics ID, and Analytics Filter and/or Analytics Target];
an association of [Analytics ID, and Analytics Filter and/or Analytics Target];
consumer NF ID;
unique ML model ID;
ML Model Information;
Analytics ID;
Analytics Filter;
Analytics Target; and
ML Model accuracy information.

NOTE: it is considered that either the association of [unique ML Model ID, Analytics ID, and Analytics Filter and/or Analytics Target] or the association of [Analytics ID, and Analytics Filter and/or Analytics Target] are included as mandatory information in the ML Model accuracy meta information.

Optionally, the ML model accuracy meta information request may comprise one or more of the following:
a flag indicating the request for ML Accuracy meta information;
feedback type defining the type of ML Model accuracy information to be generated (and/or provided) to an entity requesting such information. Another possible understanding for the feedback type is that it defines the tuple that identifies the generated (and/or monitored and/or provisioned) ML Model accuracy information. Examples of possible values for the feedback type are: general, or specific;
Analytics Accuracy Request information;
an association of [analytics ID, and Analytics Filter and/or Analytics Target];
an association of [unique ML Model Identifier, analytics ID, and Analytics Filter and/or Analytics Target]; and
an association of [unique ML Model Identifier, ML Model Filter Identifier, analytics ID, and Analytics Filter and/or Analytics Target].

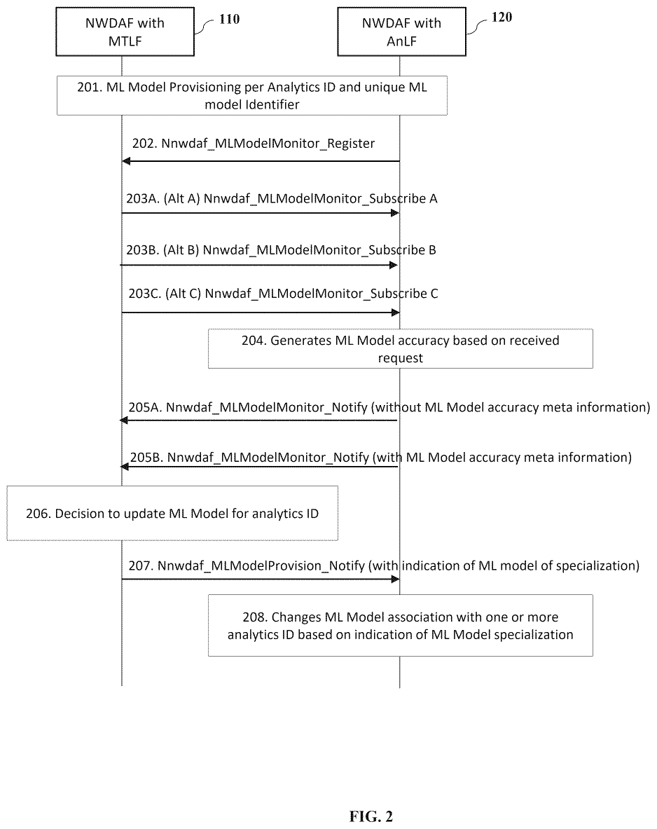

FIG. 2 shows an example of a method of the embodiments. In this example, the following principles are used:
An ML Model ID is directly associated to an association of [analytics ID, and Analytics Filter and/or Analytics Target]; and
ML Model accuracy meta information is indicative of the association of [analytics ID, and Analytics Filter and/or Analytics Target].

The method in FIG. 2 comprises the following steps or operations 201-208, which are built based on the steps or operations shown in FIG. 1. Thus, features mentioned in FIG. 2 may be applied to the steps or operations in FIG. 1.

Step or operation 201: the AnLF subscribes for one or more trained ML Model(s) associated with one or more Analytics ID(s) by invoking the Nnwdaf_MLModelProvision_Subscribe service operation from MTLF. The AnLF receives the ML Model and its associated information. For each analytics ID, AnLF is aware of the following association: analytics ID, unique ML Model identifier, ML Model Information. This association information enables AnLF to uniquely related an analytics ID to an ML Model.

Step or operation 202: the AnLF is configured to register with the MTLF that provided an ML Model to an analytics ID. The AnLF may invoke the Nnwdaf_MLModelMonitor_Register service operation from MTLF including the accuracy binding information comprising one or more associations of [unique ML Model identifier and/or ML Model Filter Information, Analytics ID, Analytics Filter and/or Analytics Target].

Step or operation 203 (as a general step or operation of steps or operations 203A-C): the MTLF determines that it needs the ML Model accuracy information from AnLF registered with the ML Model (e.g., denoting it can provide the ML Model accuracy information for ML Model). such MTLF may invoke the Nnwdaf_MLModelMonitor_Subscribe service operation from AnLF including an indication for requesting the ML Model accuracy meta information. The MTLF for instance can decide to include such indication based on the received accuracy binding information. When MTLF receives the accuracy binding information, the MTLF identifies that the AnLF that provided such accuracy binding information is capable of providing the ML model accuracy meta information.

There are at least three possible examples for indication for requesting the ML Model accuracy meta information, which are shown below in Step or operation 203A-C.

Step or operation 203A: MTLF invokes the Nnwdaf_MLModelMonitor_Subscribe service operation from AnLF. In the subscription (or request) the MTLF includes the Unique ML Model identifier, and the indication for requesting the ML Model accuracy meta information. In this example, the indication for requesting the ML Model accuracy meta information may be equivalent to the following parameters in the service request: Analytics ID, ML Model Accuracy Feedback Type: [General, Specific], optional Analytics Accuracy Request information.

Step or operation 203B: MTLF invokes the Nnwdaf_MLModelMonitor_Subscribe service operation from AnLF. In the subscription (or request) the MTLF includes the Unique ML Model identifier, and the indication for requesting the ML Model accuracy meta information. In this example, the indication for requesting the ML Model accuracy meta information is equivalent to the following parameters in the service request: Analytics ID, Analytics Filter and/or Analytics Target, optional Analytics Accuracy Request information.

Step or operation 203C: MTLF invokes the Nnwdaf_MLModelMonitor_Subscribe service operation from AnLF. In the subscription (or request) the MTLF includes the Unique ML Model identifier, and the indication for requesting the ML Model accuracy meta information. In this example, the indication for requesting the ML Model accuracy meta information is equivalent to the following parameters in the service request: Analytics ID, ML Model Accuracy meta information request.

It is also possible that the indication for requesting the ML Model accuracy meta information may comprise different combinations of the aforementioned information.

Step or operation 204: based on the information received from MTLF (e.g., indication for requesting the ML model accuracy meta information), AnLF generates the requested ML Model Accuracy Information.

If the MTLF did not include any indication for requesting ML Model accuracy meta information and/or if the indication for requesting ML Model accuracy meta information comprised the ML Model Accuracy Feedback Type set to General, the AnLF calculates the ML Model accuracy by taking into account the information (e.g., the ground truth and/or the analytics accuracy information) for a given analytics ID and unique ML Model identifier independent of the analytics Filter and/or Analytics target associated with a subscription to an analytics ID.

For instance, if AnLF has a subscription A for analytics ID X1 and analytics filter for areas of interest set to area 1, area 2 with the unique ML Model identifier Y, and another subscription B for the same analytics ID X1 with the same unique ML Model identifier Y but with analytics filter for areas of interest set to area 3, area 4, all the data related to these 2 distinct subscriptions for analytics ID may be used for the single value calculation of the ML Model accuracy information. If for subscription A the analytics accuracy information indicates a performance of 60% and for the subscription B the performance is 99%; the AnLF may calculate that the ML Model accuracy for the unique ML Model identifier Y is near 80%. This kind of calculation including together all data related to a unique ML Model identifier may imprecisely lead MTLF to believe that unique ML Model identifier Y is well trained.

If the MTLF included an indication for requesting ML Model accuracy meta information and/or if the indication for requesting ML Model accuracy meta information comprised the ML Model Accuracy Feedback Type set to Specific, the AnLF calculates the ML Model accuracy by taking into account the information (e.g., the ground truth and/or the analytics accuracy information) for a given analytics ID and unique ML Model identifier and each different combination of accuracy binding information (e.g., analytics Filter and/or Analytics target associated and analytics ID and unique ML model identifier).

For instance, if ANLF has a subscription A for analytics ID X1 and analytics filter for areas of interest set to area 1, area 2 with the unique ML Model identifier Y, and another subscription B for the same analytics ID X1 with the same unique ML Model identifier Y but with analytics filter for areas of interest set to area 3, area 4, AnLF may use the specific data of each different subscription for analytics ID (e.g., information related to the accuracy binding information) to generate the ML Model accuracy information and include the ML Model accuracy meta information. For instance, the algorithm inside AnLF operating with ML Model accuracy Meta Information may be designed to consider put different weight in the ground truth of the different areas that can be included in an Analytics filter. In this way, the AnLF could then detect that for areas 1 and 2 (e.g., with weights that highlight good calculated performance) may have an ML Model accuracy information of 80%, while for the same unique ML model identifier used in different areas of the mobile network (e.g., with weights that highlight a bad performance) the ML Model Accuracy information could be 30%. With such distinguish information, AnLF is able to provide refined ML Model accuracy information to MTLF with the meta information supporting MTLF decisions.

Step or operation 205A: if the request from MTLF did not include any indication for requesting ML Model accuracy meta information and/or if the indication for requesting ML Model accuracy meta information comprised the ML Model Accuracy Feedback Type set to General, the AnLF provides to MTLF the ML Model accuracy information by invoking the Nnwdaf_MLModelMonitor_Notify service operation from MTLF. In this case, no ML Model accuracy meta information is included in the notification.

Step or operation 205B: in alternative to step or operation 205A, if the request from MTLF included an indication for requesting ML Model accuracy meta information and/or if the indication for requesting ML Model accuracy meta information comprised the ML Model Accuracy Feedback Type set to Specific, the AnLF provides to MTLF the one or more tuple of [ML Model accuracy information with the associated ML Model accuracy meta information] by invoking the Nnwdaf_MLModelMonitor_Notify service operation from MTLF.

For instance, a possible example of one instance of the tuple can be defined as [unique ML Model identifier, ML Model Accuracy information, Analytics ID, Analytics Filter and/or Analytics Target, optional ML Model Filter Information and/or ML Model Target Information]. In this example, the ML Model accuracy meta information is equivalent to the following terms of the tuple [Analytics ID, Analytics Filter and/or Analytics Target, optionally ML Model Filter Information and/or ML Model Target Information], and such ML model accuracy information defines that the ML Model accuracy information associated with the unique ML Model identifier is further associated with the further term of such tuple (i.e., the ML Model accuracy meta information). In another possible embodiment of the ML Model Accuracy meta information, such information is comprised of the following terms: (ML Model accuracy information, Analytics ID, Analytics Filter and/or Analytics Target, optionally ML Model Filter Information and/or ML Model Target Information). In this case, the association of the ML Model accuracy information is part of the ML Model accuracy meta information, and it would be equivalent to define the unique ML model identifier is associated with the ML Model Accuracy meta information.

Step or operation 206: based on the information received from AnLF (e.g., for one unique ML model identifier one or more tuple of (ML model accuracy information, ML Model accuracy meta information), the MTLF can detect whether for a given unique ML model identifier, changes are necessary.

Examples of possible changes enforced by the MTLF based on the ML Model accuracy meta information received from AnLF are described as follows.
a) Creating and/or train a new ML Model with a new unique ML Model identifier based on the previous ML Model associated with the unique ML model identifier further related to a received ML Model Accuracy meta information. In this case, the new trained and/or created ML Model can be a refinement of the previous ML model, for instance, can be trained with only part of the entire dataset (and/or type of data set information and/or type of data set characteristics). For instance, if a previous ML Model was trained with the data set characteristic, for instance, representing all tracking areas of the mobile network, the new ML model is a specialization of the previous ML model for instance because it is trained for a reduce list (or set) of tracking areas of the mobile network. This is only to possible type o data set characteristic, other example may include: type of application, type of slice, slice identification, type of radio access technology, type of users (e.g., stationary users, mobile users), type sessions, data network identifications, and any other field defined in the Analytics Filter Information as per 3GPP TS 23.288).
b) Selecting a new ML model and associated new unique ML Model identifier, where the new ML Model is associated with ML Model Filters that are better suitable analytics ID associated with the ML Model accuracy meta information. For instance, the MTLF could select a new ML Model that was already trained to support the specific analytics filter information indicated in the ML Model accuracy meta information.

Step or operation 207: the MTLF provides to AnLF a notification indicating changes in the ML Model association to an analytics ID the Nnwdaf_MLModelProvision_Notify service operation. In one possible embodiment, the input parameters of the message include the indication of ML Model specialization which can comprise any of the possible information:
Tuple with [new unique ML Model identifier, analytics ID, Analytics Filter Information and/or Analytics Target, new ML Model Information, new ML Model Filter Information]
Tuple with [previous unique ML model identifier, new unique ML Model identifier, analytics ID, Analytics Filter Information and/or Analytics Target, new ML Model Information, new ML Model Filter Information].

Step or operation 208: Based on the ML Model specialization (or indication of ML model specialization), the AnLF determines which analytics IDs associated with a previous unique ML model identifier may be re-associated with the new unique ML model identifier and/or new ML Model Information. The AnLF then re-associates the analytics IDs with Analytics Filter and/or Analytics target to the new unique ML Model identifier and/or ML Model Information.

The AnLF may trigger its registration as provider of ML Model accuracy information as per step or operation 202 with the new unique ML model identifier and respective accuracy binding information.

It is also possible that the AnLF changes the existing accuracy binding information from the existing registration information for the previous unique ML model with the analytics ID to reflect the dissociation of the analytics ID with analytics filters and/or analytics target with the previous unique ML model identifier. This allows MTLF to keep the consistent map of which AnLF is providing the ML Model accuracy for the unique ML Model identifier with its proper accuracy binding information.

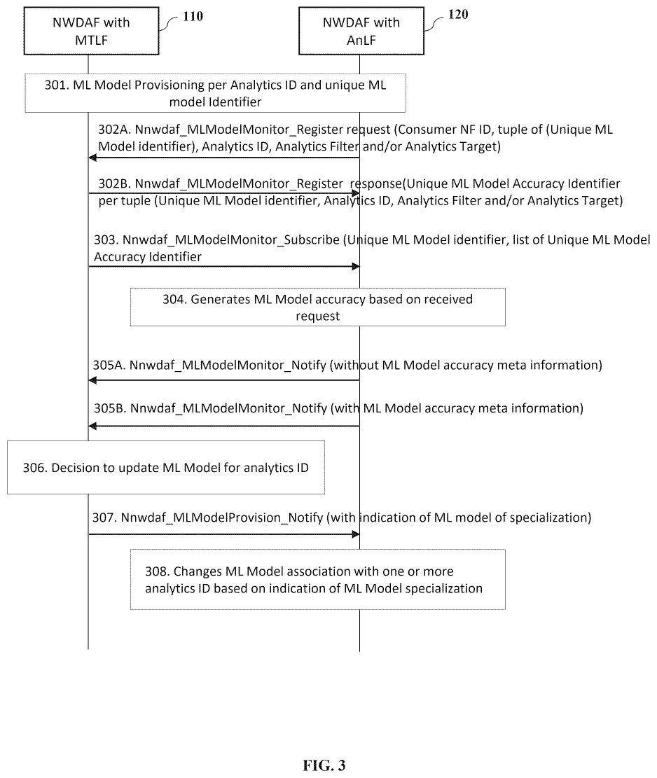

FIG. 3 shows a further example of a method of the embodiments. In this example, the following principles are used:
When AnLF register to MTLF to indicate its capability of ML Model monitoring for a given unique ML model identifier, these two entities exchange information in order to pair the association of unique ML Model identifier to new proposed Unique ML Model Accuracy Identifier; and
ML Model accuracy meta information is indicative of unique ML Model Accuracy Identifier, which is associated with the tuple [analytics ID, and Analytics Filter and/or Analytics Target].

The method in FIG. 3 comprises the following steps or operations 301-308, which are built based on the steps or operations in FIG. 1. Features introduced with respect to FIG. 3 may be similarly applied to FIG. 1.

Step or operation 301: the same as Step or operation 201 in FIG. 2.

Step or operation 302: the AnLF decides to register with the MTLF that provided an ML Model to an analytics ID.

Step or operation 302A: the AnLF may invoke the Nnwdaf_MLModelMonitor_Register request service operation from MTLF including the one or more accuracy binding information, comprising one or more tuples of [unique ML Model identifier and/or ML Model Filter Information, Analytics ID, Analytics Filter and/or Analytics Target].

Step or operation 302B: the MTLF is configured to map, for each tuple [unique ML model identifier, accuracy binding information], a unique ML Model Accuracy identifier, and then provide to the AnLF the in the Nnwdaf_MLModelMonitor_Register response service operation such mapping information, e.g., for each unique ML model identifier the unique ML Model accuracy identifier for an accuracy binding information. This received mapping information is stored by AnLF so that it can use such mapping information later on to generate the ML model accuracy meta information for the one or more ML Model accuracy information associated with the same unique ML Model identifier.

Step or operation 303: the MTLF determines that it needs the ML Model accuracy information from AnLF registered with the ML Model (e.g., denoting it can provide the ML Model accuracy information for such ML Model). MTLF may invoke the Nnwdaf_MLModelMonitor_Subscribe service operation from AnLF including an indication for requesting the ML Model accuracy meta information. The MTLF for instance may decide to include such indication based on the received accuracy binding information. When MTLF receives the accuracy binding information, the MTLF identifies that the AnLF that provided such accuracy binding information is capable of providing the ML model accuracy meta information.

In this example, the indication for requesting the ML model accuracy meta information may be equivalent to the MTLF providing (e.g., including in the request) the one or more unique ML Model accuracy identifiers associated with the unique ML Model identifier. It is also possible that the indication for requesting the ML Model accuracy meta information may comprise ML Model Accuracy Feedback Type: [General, Specific], and/or Analytics Accuracy Request information.

Step or operation 304: based on the information received from MTLF (e.g., indication for requesting the ML model accuracy meta information), AnLF generates the requested ML Model Accuracy Information.

If the MTLF does not include any indication for requesting ML Model accuracy meta information and/or if the indication for requesting ML Model accuracy meta information comprised the ML Model Accuracy Feedback Type set to General, AnLF calculates the ML Model accuracy in the same way as described in Step or operation 204 in FIG. 2.

If the MTLF includes an indication for requesting ML Model accuracy meta information and/or if the indication for requesting ML Model accuracy meta information comprised the ML Model Accuracy Feedback Type set to Specific, the AnLF calculates the ML Model accuracy by taking into account the information (e.g., the ground truth and/or the analytics accuracy information) for a given analytics ID and unique ML Model identifier and each different combination of unique ML Model accuracy identifier and/or accuracy binding information (e.g., analytics Filter and/or Analytics target associated and analytics ID and unique ML model identifier). The same example of calculation listed in step or operation 204 from FIG. 2 may apply to this embodiment.

Step or operation 305A: if the request from MTLF does not include any indication for requesting ML Model accuracy meta information and/or if the indication for requesting ML Model accuracy meta information comprised the ML Model Accuracy Feedback Type set to General, the AnLF provides to MTLF the ML Model accuracy information by invoking the Nnwdaf_MLModelMonitor_Notify service operation from MTLF. In this case, no ML Model accuracy meta information is included in the notification.

Step or operation 305B: if the request from MTLF included an indication for requesting ML Model accuracy meta information and/or if the indication for requesting ML Model accuracy meta information comprised the ML Model Accuracy Feedback Type set to Specific, the AnLF provides to MTLF the one or more tuple of [ML Model accuracy information with the associated ML Model accuracy meta information] by invoking the Nnwdaf_MLModelMonitor_Notify service operation from MTLF.

For instance, an example of one instance of the tuple can be defined as ML Model Accuracy information for a unique ML Model identifier associated with a unique ML Model accuracy identifier. In this possible example, the ML Model accuracy meta information is equivalent to the following terms of such tuple [a unique ML Model identifier associated with a unique ML Model accuracy identifier].

Step or operation 306: the same as Step or operation 206 in FIG. 2.

Step or operation 307: based on step or operation 207 in FIG. 2 with the difference that:
a. The MTLF provides to AnLF a notification indicating changes in the ML Model association to an analytics ID the Nnwdaf_MLModelProvision_Notify service operation. In one possible embodiment, the input parameters of the message include the indication of ML Model specialization which can comprise any of the possible information:
   Tuple with [new unique ML Model identifier, analytics ID, unique ML Model Accuracy identifier, new ML Model Information, new ML Model Filter Information]
   Tuple with [previous unique ML model identifier, new unique ML Model identifier, analytics ID, unique ML Model Accuracy identifier, new ML Model Information, new ML Model Filter Information].

Step or operation 308: the same as step or operation 208 in FIG. 2.

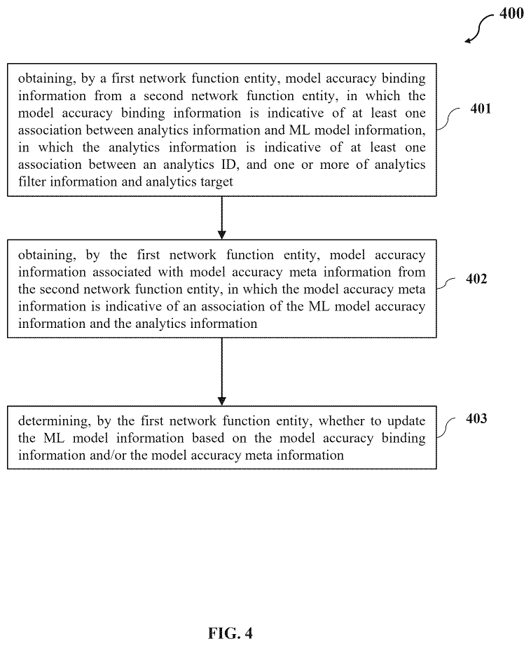

FIG. 4 shows a diagram of a method applied to a first network function entity of the embodiments. The method comprises the following steps or operations:

Step or operation 401: obtaining, by the first network function entity, model accuracy binding information from a second network function entity, in which the model accuracy binding information is indicative of at least one association between analytics information and ML model information, in which the analytics information is indicative of at least one association between an analytics ID, and one or more of analytics filter information and analytics target;

Step or operation 402: obtaining, by the first network function entity, model accuracy information associated with model accuracy meta information from the second network function entity (120), wherein the model accuracy meta information is indicative of an association of the ML model accuracy information and the analytics information; and

Step or operation 403: determining, by the first network function entity, whether to update the ML model information based on the model accuracy binding information and/or the model accuracy meta information.

The method of FIG. 4 may share the corresponding features mentioned above with respect to FIG. 1-3.

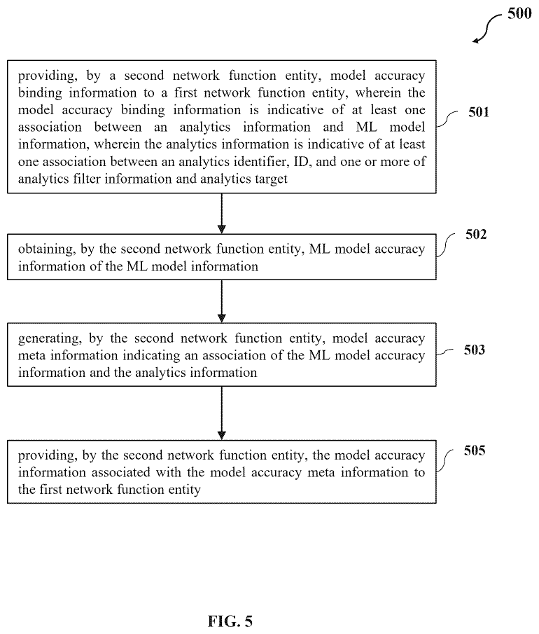

FIG. 5 shows a diagram of a method applied to a second NF entity of the embodiments. The method comprises the following steps or operations:

Step or operation 501: providing, by the second network function entity, model accuracy binding information to a first network function entity, wherein the model accuracy binding information is indicative of at least one association between an analytics information and ML model information, wherein the analytics information is indicative of at least one association between an analytics identifier, ID, and one or more of analytics filter information and analytics target;

Step or operation 502: obtaining, by the second network function entity, model accuracy information of the ML model information;

Step or operation 503: generating, by the second network function entity, model accuracy meta information indicating an association of the ML model accuracy information and the analytics information; and

Step or operation 504: providing, by the second network function entity, the model accuracy information associated with the model accuracy meta information to the first network function entity.

The method of FIG. 5 may share the corresponding features mentioned above with respect to FIG. 1-4.

In summary, the embodiments provide a solution for optimizing ML model accuracy monitoring, provisioning, re-training, and update in a mobile communication network. The embodiments may be applied to any type of mobile communication network including but not limited to 5G, 6G cellular system, or any network built based on such mobile communication network (e.g., IoT network, V2X network, etc.).

It is noted that the entities in the embodiments may comprise processing circuitry configured to perform, conduct or initiate the various operations of the device described herein, respectively. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. Optionally, the processing circuitry comprises one or more processors and a non-transitory memory connected to the one or more processors. The non-transitory memory may carry executable program code which, when executed by the one or more processors, causes the device to perform, conduct or initiate the operations or methods described herein, respectively.

The embodiments have been described in conjunction with various aspects and implementations. However, other variations may be understood and effected by those skilled in the art from consideration of the drawings, the embodiments, and the description. In the description, the word “comprising” does not exclude other elements or steps or operations, and the indefinite article “a” or “an” does not exclude a plurality. A single element or unit may fulfill the functions of several entities or items recited in the claims. The mere fact that certain features are recited in different dependent claims does not indicate that a combination of these features cannot be used in an implementation.

1. A first network function entity for machine learning (ML) model training in a mobile communication network, the first network function entity being configured to:
obtain model accuracy binding information from a second network function entity, wherein the model accuracy binding information is indicative of at least one association between analytics information and ML model information, wherein the analytics information is indicative of at least one association between an analytics identifier (ID) and one or more of analytics filter information and an analytics target;
obtain ML model accuracy information associated with model accuracy meta information from the second network function entity, wherein the model accuracy meta information is indicative of an association of the ML model accuracy information and the analytics information; and
determine whether to update the ML model information based on at least one of the model accuracy binding information and/or the model accuracy meta information.

2. The first network function entity according to claim 1, wherein the model accuracy meta information is further indicative of an association of analytics accuracy information and one or more of: an analytics ID, the analytics filter information, the analytics target, and the ML model information.

3. The first network function entity according to claim 1, wherein the first network function entity is configured to obtain the model accuracy binding information from a request from the second network function entity, wherein the request is indicative that the second network function entity is able to provide the ML model accuracy information with respect to the ML model information comprised in the model accuracy binding information.

4. The first network function entity according to claim 1, wherein the first network function entity is configured to send indication information to the second network function entity for requesting the model accuracy meta information.

5. The first network function entity according to claim 4, wherein the indication information for requesting the model accuracy meta information is comprised in a subscription request sent by the first network function entity to the second network function entity.

6. The first network function entity according to claim 4, wherein the indication information for requesting the model accuracy meta information comprises one or more of:
a flag indicating whether the model accuracy meta information is required;
an ML model ID associated with an analytics ID;
an ML model ID associated with one or more of an analytics ID, analytics filter information, and an analytics target;
an ML model ID associated with one or more ML model accuracy IDs, wherein each ML model accuracy ID identifies at least one ML model ID association with at least one analytics ID, and at least one of analytics filter information and an analytics target; and
one or more ML model accuracy IDs, wherein each ML model accuracy ID identifies a tuple of an ML model ID and corresponding analytics information.

7. The first network function entity according to claim 1, further configured to:
update the ML model information based on the model accuracy meta information, wherein the updated ML model information is associated with a new ML model ID or with a previous ML model ID.

8. The first network function entity according to claim 7, wherein, for updating the ML model information, the first network function entity is configured to perform one or more of:
determining new ML model information as the updated ML model information; and
retraining the ML model to obtain a retrained ML model in order to update the ML model information.

9. The first network function entity according to claim 7, further configured to:
provide at least one of the updated ML model information and an ML model specialization indication to the second network function entity, wherein the ML model specialization indication is indicative of an association between corresponding analytics information and at least one of the ML model information and/or the updated ML model information.

10. A second network function entity for supporting machine learning (ML) model training in a mobile communication network, the second network function entity being configured to:
provide model accuracy binding information to a first network function entity, wherein the model accuracy binding information is indicative of at least one association between analytics information and ML model information, wherein the analytics information is indicative of at least one association between an analytics identifier (ID) and one or more of analytics filter information and an analytics target;
obtain ML model accuracy information for the ML model information;
generate model accuracy meta information indicating an association of the ML model accuracy information and the analytics information; and
provide the ML model accuracy information associated with the model accuracy meta information to the first network function entity.

11. The second network function entity according to claim 10, wherein the model accuracy meta information further comprises analytics accuracy information associated with one or more of an analytics ID, the analytics filter information, the analytics target, and the ML model information.

12. The second network function entity according to claim 10, wherein the second network function entity is configured to provide the model accuracy binding information to the first network function entity through a request, wherein the request is indicative that the second network function entity is able to provide the ML model accuracy information with respect to the ML model information comprised in the model accuracy binding information.

13. The second network function entity according to claim 10, wherein, for providing the model accuracy meta information, the second network function entity is further configured to receive indication information from the first network function entity for requesting the model accuracy meta information.

14. The second network function entity according to claim 10, further configured to:
receive at least one of updated ML model information and an ML model specialization indication from the first network function entity, wherein the ML model specialization indication is indicative of an association between corresponding analytics information and at least one of the ML model information and/or the updated ML model information; and
update the ML model information based on at least one of the updated ML model information and the ML model specialization indication.

15. A system comprising at least one first network function entity, and at least one second network function entity,
wherein the at least one first network function entity is configured to:
obtain model accuracy binding information, wherein the model accuracy binding information is indicative of at least one association between analytics information and machine learning (ML) model information, wherein the analytics information is indicative of at least one association between an analytics identifier (ID) and one or more of analytics filter information and an analytics target;
obtain ML model accuracy information associated with model accuracy meta information, wherein the model accuracy meta information is indicative of an association of the ML model accuracy information and the analytics information; and
determine whether to update the ML model information based on at least one of the model accuracy binding information and/or the model accuracy meta information; and
wherein
the at least one second network function entity is configured to:
send the model accuracy binding information to the at least one first network function entity;
obtain the ML model accuracy information of for the ML model information;
generate the model accuracy meta information; and
send the ML model accuracy information associated with the model accuracy meta information to the at least one first network function entity.

16. The system according to claim 15, wherein the first network function entity is configured to obtain the model accuracy binding information from a request from the second network function entity, wherein the request is indicative that the second network function entity is able to provide the ML model accuracy information with respect to the ML model information comprised in the model accuracy binding information.

17. The system according to claim 15, wherein the first network function entity is configured to send indication information to the second network function entity for requesting the model accuracy meta information.

18. The system according to claim 17, wherein the indication information for requesting the model accuracy meta information is comprised in a subscription request sent by the first network function entity to the second network function entity.

19. The system according to claim 18, wherein the indication information for requesting the model accuracy meta information comprises one or more of:
a flag indicating whether the model accuracy meta information is required;
an ML model ID associated with an analytics ID;
an ML model ID associated with one or more of an analytics ID, analytics filter information, and an analytics target;
an ML model ID associated with one or more ML model accuracy IDs, wherein each ML model accuracy ID identifies at least one ML model ID association with at least one analytics ID, and at least one of analytics filter information and an analytics target; and
one or more ML model accuracy IDs, wherein each ML model accuracy ID identifies a tuple of an ML model ID and corresponding analytics information.
